(19) United States
(12) Patent Application Publication
(10) Pub. No.: US 2009/0096578 A1
(43) Pub. Date: Apr. 16, 2009

(54) SMART ENTRY SYSTEM

(75) Inventors: Kenichi Ogino, Tokyota-city (JP); Kentaro Teshima, Kariya-city (JP); Kazuhiro Nakashima, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/252,512

(22) Filed: Oct. 16, 2008

(30) Foreign Application Priority Data
Oct. 16, 2007 (JP) 2007-268879

(51) Int. Cl. B60R 25/00

(52) U.S. Cl. 340/5.72

(57) ABSTRACT

When a master portable unit exists inside a vehicle compartment and a sub-portable unit exists outside the vehicle compartment, master portable unit disable control is performed and door lock control is performed. Thus, even if the master portable unit put in a bag or a jacket is not taken out, the door can be locked. Accordingly, when the user holds the sub-portable unit and goes out of the vehicle compartment while leaving the master portable unit in the vehicle compartment, locking can be performed. Further, even if an unauthorized user breaks the glass and enters the vehicle compartment when the user carries the sub-portable unit and exists outside the vehicle, operations such as starting an engine by using the master portable unit can be disabled.

### CROSS REFERENCE TO RELATED APPLICATION

This application is based on and incorporates herein by reference Japanese Patent Application No. 2007-268879 filed on Oct. 16, 2007.

### FIELD OF THE INVENTION

The present invention relates to a smart entry system, in which door lock control, door unlock control or the like is performed when a user carrying a portable unit gets on or off a vehicle.

### BACKGROUND OF THE INVENTION

A conventional smart entry system performs door lock and unlock control based on communication between a portable unit carried by a user and a transmitter/receiver mounted in a vehicle.

In the smart entry system, a transmitter/receiver device mounted in a vehicle communicates with a portable unit carried by a user to cause the portable unit to send back a response signal including an identification code. The transmitter/receiver device receives the signal including the identification code through a reception antenna mounted in the vehicle for communication with the outside of a vehicle compartment. The release of door lock is permitted, when the signal is received. When the user or a passenger actually touches the door and a door operation is performed, door unlock is performed. Besides, in the smart entry system, a reception antenna for detecting whether the portable unit exists inside the vehicle compartment is provided also in the vehicle compartment. It is checked whether the portable unit exists inside the vehicle compartment by performing communication similar to the above, and based on this determination result, it is checked whether the user gets on or off the vehicle, and the operation of a push start switch for stating the engine is permitted.

Thus, in the smart entry system, when the user approaches the vehicle while carrying the portable unit, and operates a door knob or operates a lock switch or an unlock switch of the door knob, even if a mechanical key operation is not performed, the door can be locked or unlocked. When the user gets in the vehicle compartment, the engine can be started by operating the push start switch.

In the vehicle having such a smart entry system, the user often holds the portable unit in a bag, a wallet, a jacket or the like. Thus, for example, when the user gets off the vehicle to shop something in a store, unless the bag or the jacket containing the portable unit is intentionally taken out from the vehicle, the locking of the door cannot be performed.

Besides, for example, the user may temporarily get out of the vehicle to buy a drink at a nearby vending machine, while leaving the engine operating. In this case, when the user goes out while wearing the jacket containing the portable unit, that is, when the portable unit is taken out in the state where the engine is operating, a take-out warning will be sounded.

JP 2000-145222A proposes a smart entry system, in which two portable units are used. In some cases, one of the portable units is left in a vehicle compartment and the user carrying the other portable unit goes away from the vehicle. The distance from the vehicle to the other portable unit is detected based on the electric field intensity of a response signal sent back from the portable unit. When the distance becomes large and the user certainly goes away from the vehicle, automatic door lock is performed thereby to prevent unauthorized use of the vehicle by any third person.

The operation of door lock or door unlock based on the signal of the other portable unit left in the vehicle compartment is disabled. When the one portable unit carried by the user approaches, and the door is again brought into the unlock state, the operation of door lock or door unlock is enable again based on the signal of the other portable unit.

However, in the system of JP 2000-145222A, although the operation of door lock or door unlock based on the signal of the other portable unit left in the vehicle compartment is disabled, control by the other portable unit is enabled when the door is again brought into the unlock state. Accordingly, even when the unlock state is caused by breaking the window and entering the vehicle through the broken window, the control by the other portable unit is enabled. Thus, the vehicle is likely to be used by an unauthorized user.

Besides, although the user's leaving from the vehicle is detected based on the electric field intensity of the signal of the one portable unit carried by the user, because of the directivity of the electric field, the electric field intensity varies by the influence of the way of holding the portable unit. Thus, the distance from the vehicle to the portable unit cannot be detected accurately. Accordingly, since the electric field intensity is used, the operation cannot be accurately performed.

### SUMMARY OF THE INVENTION

It is a first object of the invention to enable locking of a door without using electric field intensity and without take-out a portable unit held in a bag or a jacket.

It is a second object of the invention to provide a smart entry system, in which even if a portable unit is intentionally taken out from a vehicle compartment while the engine is in operation, a take-out warning is not issued.

According to the first aspect of the present invention, a smart entry system comprises a portable unit including a master portable unit and a sub-portable unit operable as electronic keys, and a vehicle-mounted device having a communicable area inside a vehicle compartment and a communicable area outside the vehicle compartment for communication with the portable unit. The he vehicle-mounted device includes a transmitter/receiver device that communicates with the master portable unit and the sub-portable unit, door lock/unlock operation switches that perform lock and unlock operations of the door at an outside of the vehicle compartment, a control unit that issues an execution instruction of lock control and unlock control of the door based on an operation state of the door lock/unlock operation switches, and a lock/unlock driver unit that executes the lock control and the unlock control based on the execution instruction of the lock control and the unlock control of the door by the control unit. The control unit is configured to execute, when the lock operation is performed by the door lock/unlock operation switches, master portable unit disable control to thereby disable the master portable unit to function as the electronic key, and cause the lock/unlock driver unit to perform the lock control, upon determining that the master portable unit is inside the vehicle compartment and the sub-portable unit is outside the vehicle compartment.

According to the second aspect of the present invention, a smart entry system comprises a portable unit including a master portable unit and a sub-portable unit operable as electronic keys, and a vehicle-mounted device having a communicable area inside a vehicle compartment and a communicable area outside the vehicle compartment for communication with the portable unit. The vehicle-mounted device includes a transmitter/receiver device that communicates with the master portable unit and the sub-portable unit, a door open/close detection unit that detects an open/close operation of a door of the vehicle, a control unit that executes the take-out warning control based on a detection result of the door open/close detection unit and whether the engine is in operation, and a warning device that issues a take-out warning based on the take-out warning control. The control unit is configured to stop the take-out warning by the take-out warning control, upon determining that the master portable unit exists inside the vehicle compartment and the sub-portable unit is outside the vehicle compartment.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram of a smart entry system according to an embodiment of the invention.

FIG. 2 is a schematic view for explaining check areas in the embodiment;

FIG. 3 is a schematic view showing an example of a mount location of a sub-portable unit in the embodiment;

FIG. 4 is a flowchart showing a lock control process executed in the embodiment.

FIG. 5 is a flowchart showing an unlock control process executed in the embodiment;

FIG. 6 is a flowchart of a take-out warning control process executed in the embodiment; and

FIG. 7 is a schematic view showing another example of mount location of the sub-portable unit.

### DETAILED DESCRIPTION OF THE EMBODIMENT

### Embodiment

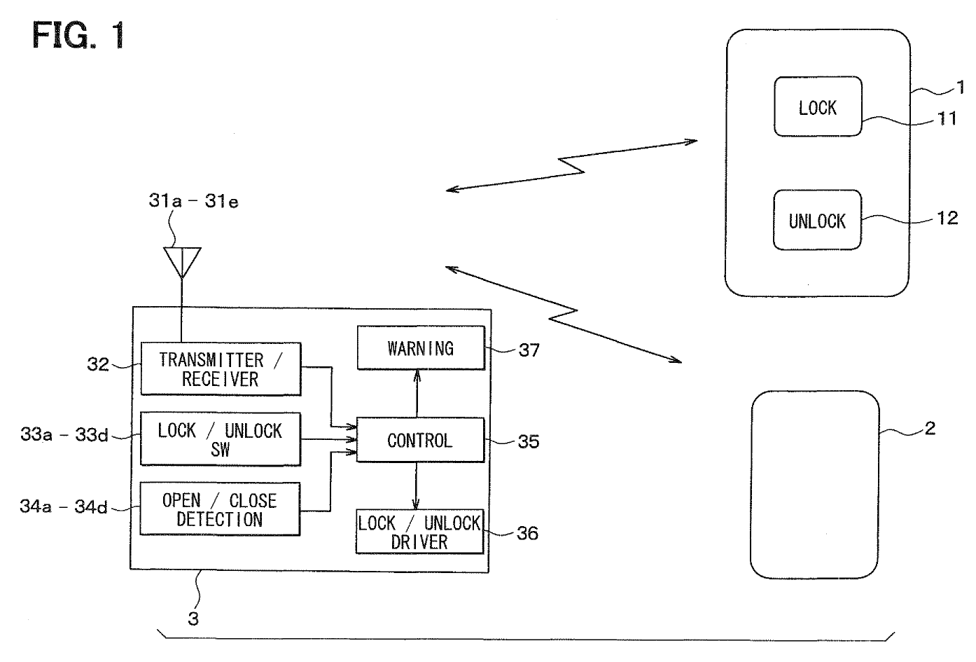

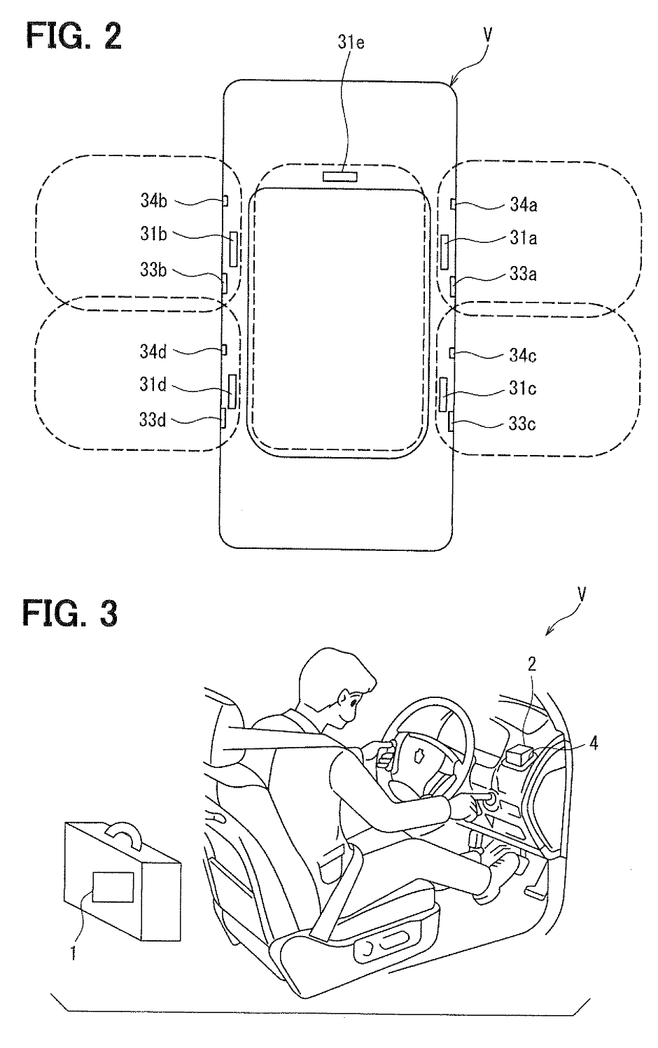

Referring first to FIG. 1, a smart entry system includes a master portable unit 1 to be carried by a user such as a vehicle driver, a furnished sub-portable unit 2 mounted in a vehicle V (FIG. 2 and FIG. 3), and a vehicle-mounted device 3 fitted to the vehicle side.

The master portable unit 1 has an identification code (ID code), which is specific to each vehicle V, and has a function in which when an identification code transmission request is issued from the vehicle-mounted device 3 in order to check an identification code, a frame storing the identification code is transmitted to the vehicle-mounted device 3. This function varies according to the form of the smart entry system. For example, the frame storing the identification code is transmitted from the master portable unit 1 side at constant periods so that the identification code is informed to the vehicle-mounted device 3 side as a response signal, so that the check of the identification code can be made to be performed. The master portable unit 1 includes also a lock switch 11 and an unlock switch 12 for performing remote control of locking and unlocking a door. When the lock switch 11 or the unlock switch 12 is operated, a signal indicating that effect is outputted from the master portable unit 1, and is transmitted to the vehicle-mounted device 3.

The sub-portable unit 2 is mounted in the vehicle V, and is temporarily used when the user puts the master portable unit 1 in a location where it is difficult to take out, such as a bag or a jacket. Similarly to the master portable unit 1, the sub-portable unit 2 has an identification code determined for each vehicle V, and has a function in which when an identification code transmission request is issued from the vehicle-mounted device 3 in order to check an identification code, a frame storing the identification code is transmitted to the vehicle-mounted device 3. The identification code of the sub-portable unit 2 is made a different code (identification code for sub-portable unit) so that it can be differentiated from the identification code of the master portable unit 1. Although the sub-portable unit 2 also includes a switch which can perform remote control of locking or unlocking the door, since the sub-portable unit 2 may be simple, its structure is made such that the identification code is stored and only communication with the vehicle-mounted device 3 can be performed.

An example of the mount location of the sub-portable unit 2 is shown in FIG. 2. Specifically, for example, a container recess 4 is provided on an instrument panel for receiving the sub-portable unit 2 therein. The container recess 4 is disposed at the position where the sub-portable unit 2 can be easily fitted in and taken out when the user temporarily uses it.

The vehicle-mounted device 3 includes a transmitter/receiver device 32 including antennas 31a to 31e, door lock/unlock operation switches 33a to 33d, door open/close detection units 34a to 34d, a control unit 35, a lock/unlock driver unit 36 and a warning device 37.

The transmitter/receiver device 32 includes the antennas 31a to 31d that receive and transmit radio signals, and functions as an input/output unit that transmits a request signal, which is a frame indicating an identification code is transmission request to the master portable unit 1 through the antennas 31a to 31e, and receives a response signal, which is a frame storing the identification code and sent back from the master portable unit 1 through the antennas 31a to 31e.

As shown in FIG. 2 by dotted lines, the antennas 31a to 31d of the transmitter/receiver device 32 have communicable areas (check areas) outside a vehicle compartment, and the antenna 31e has a communicable area (check area) inside the vehicle compartment. The number of the antennas 31a to 31d in which the check areas outside the vehicle compartment are the communicable areas is equal to the number of doors. A trigger is issued when the user touches the door lock/unlock operation switches 33a to 33d provided in the vehicle V, and the vehicle-mounted device 3 transmits the frame indicating the identification code transmission request through the transmitter/receiver device 32 and the respective antennas 31a to 31e, and confirms the location where the master portable unit 1 or the sub-portable unit 2 exists.

Specifically, when the frame storing the identification code is sent back from the master portable unit 1 or the sub-portable unit 2, the transmitter/receiver device 32 sends the frame together with information indicating which of the antennas 31a to 31e receives it, to the control unit 35. Thus, based on whether the frame storing the identification code is sent back from the master portable unit 1 or the sub-portable unit 2, and further, based on which of the antennas 31a to 31e receives the sent back frame, the control unit 35 determines whether the master portable unit 1 or the sub-portable unit 2 exists in the communicable areas of the antennas 31a to 31d outside the vehicle compartment or the communicable area of the antenna 31e inside the vehicle compartment, or determines that it does not exist in any communicable areas.

The transmitter/receiver device 32 has also a function in which, when the lock switch 11 or the unlock switch 12 of the master portable unit 1 is operated by the user and the master portable unit 1 outputs an instruction signal indicating that effect, the instruction signal is received and is transmitted to the control unit 35.

The door lock/unlock operation switches 33a to 33d are switches, by which the passenger including the user performs the lock operation or the unlock operation of the door outside the vehicle compartment, and correspond to, for example, lock/unlock switches provided on door knobs on the outside of the vehicle compartment to be operated at an outside of the vehicle V. The door lock/unlock operation switches 33a to 33d are constructed of, for example, sensors to detect the touch with the switches, such as electrostatic sensors, touch sensors, approach sensors, or photoelectric sensors.

The door lock/unlock operation switches 33a to 33d have various modes, and vary according to the vehicle type. For example, one switch may perform both locking and unlocking, two switches may separately perform locking and unlocking, or one switch and the lever itself of the door knob may be made to function as the switch, though being different by kinds of the vehicles. All these modes are included in the door lock/unlock operation switches 33a to 33d here. In this embodiment, it is assumed that the vehicle V has four doors, and the door lock/unlock switches 33a to 33d respectively provided for the four doors are illustrated. However, actually, the number of the switches corresponds to the number of doors. The output corresponding to the detection result of the door lock/unlock operation switches 33a to 33d is transmitted to the control unit 35.

The door open/close detection units 34a to 34d are for detecting the open/close state of the door provided in the vehicle V, and for example, a courtesy switch or the like is used. The door open/close detection units 34a to 34d are provided for the respective doors. In this embodiment, it is assumed that the vehicle V has four doors, and the door lock/unlock switches 34a to 34d provided for the respective four doors are illustrated. However, actually, the number thereof corresponds to the number of doors. The output corresponding to the detection result of the door open/close detection units 34a to 34d is transmitted to the control unit 35.

The control unit 35 instructs the transmitter/receiver device 32 to output the frame indicating the identification code transmission request to the master portable unit 1 or the sub-portable unit 2. Besides, the control unit 35 inputs the frame storing the identification code received by the transmitter/receiver device 32 from the master portable unit 1 or the sub-portable unit 2, checks whether the previously stored identification code specific to the vehicle V coincides with the identification code stored in the frame, and issues execution instructions of the lock control or unlock control of the door, take-out warning control and the like based on the check result, the operation of the door lock/unlock operation switches 33a to 33d, the detection result of the door open/close detection units 34a to 34d and the like. Besides, when the take-out warning control is performed, a signal indicating the operating state of the engine (signal indicating whether the engine is operating) is also used. With respect to the signal indicating the operating state of the engine, for example, information relating to the engine speed has only to be inputted from the engine ECU to the control unit 35. The details of the lock control or unlock control of the door, the take-out warning control process and the like will be described later.

Incidentally, also when the lock switch 11 or the unlock switch 12 of the master portable unit 1 is operated, the control unit 35 issues the execution instruction of the lock control or unlock control to the lock/unlock driver unit 36 in order to lock or unlock the door, However, since this process is similar to that of the related art, its description will be omitted.

The lock/unlock driver unit 36 performs the lock control or the unlock control based on the execution instruction of the lock control or the unlock control from the control unit 35. For example, as the lock control, a not-shown actuator is driven to lock the door, or as the unlock control, the not-shown actuator is driven to unlock the door.

The warning device 37 is for warning the user that the master portable unit 1 is taken out of the vehicle compartment while the engine is left operating, and the warning is given by, for example, a voice or the like. As the warning device 37, for example, a sound generation device such as a horn or an audio can be used.

Next, the operation based on the control process including the door lock control process and unlock control process by the smart entry system will be described.

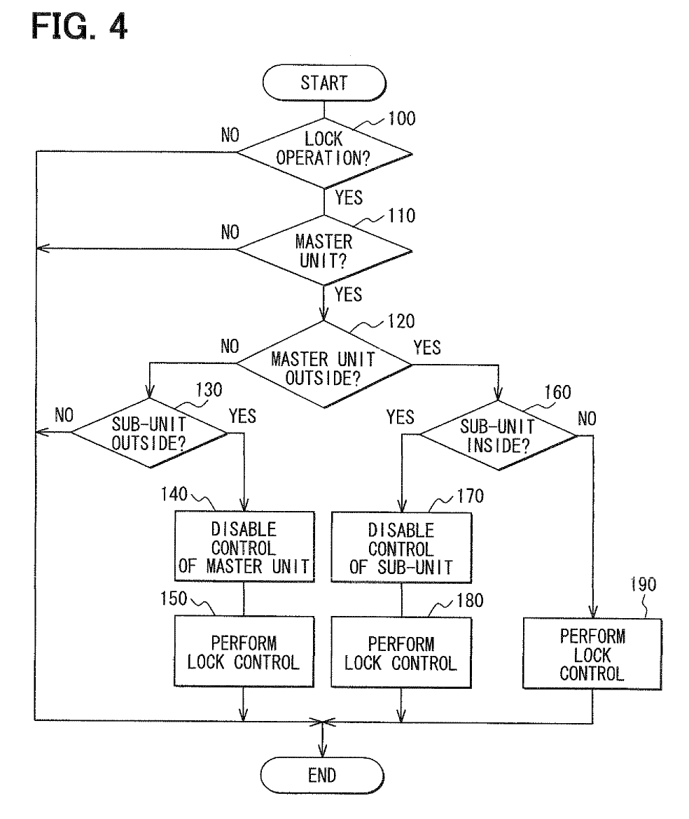

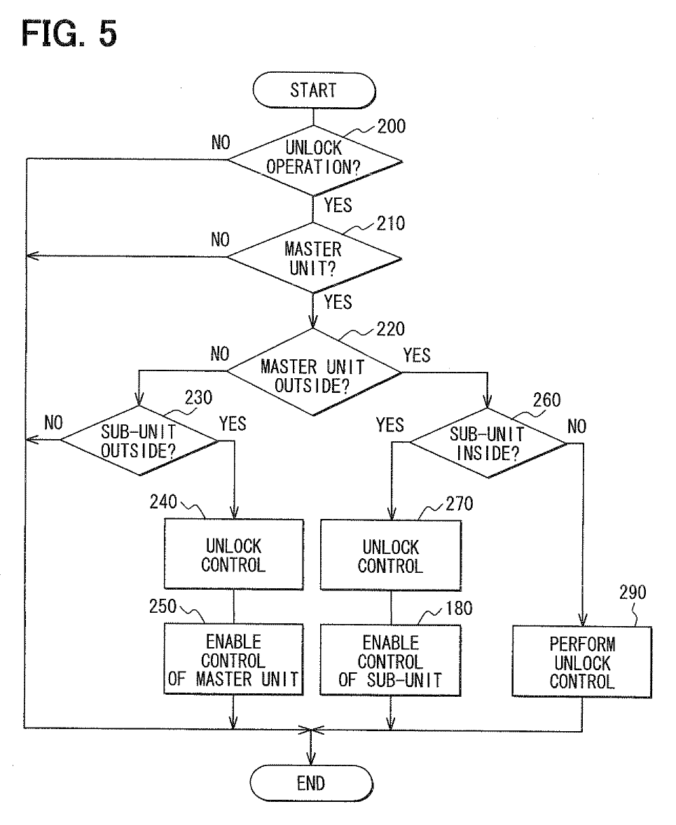

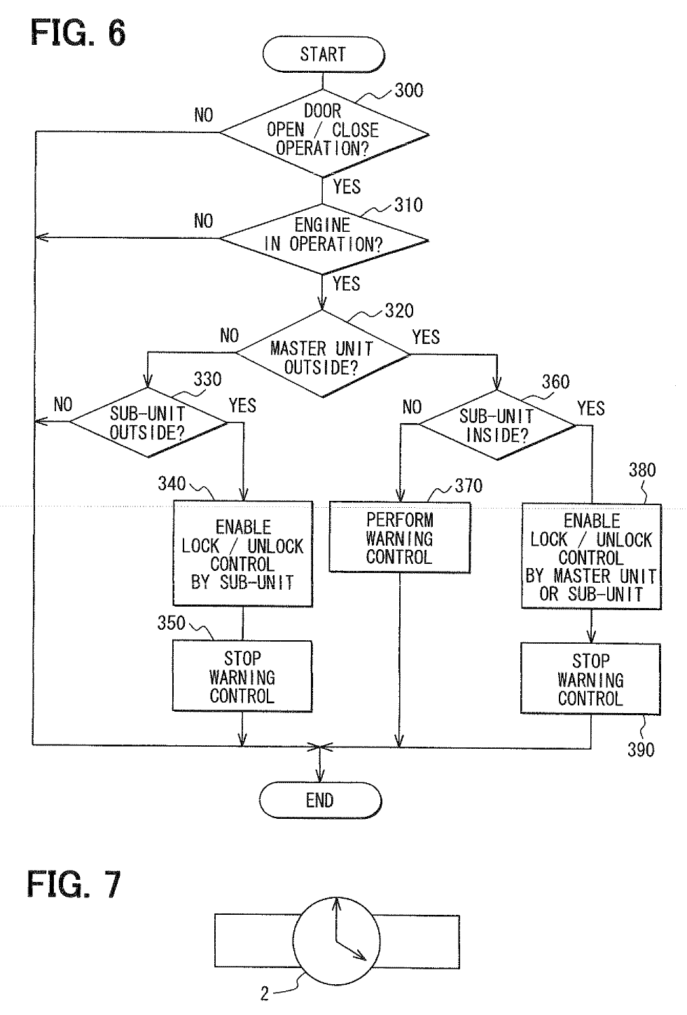

The control unit 35 is programmed to execute various processes, which include the lock control process, the unlock control process, and the take-out warning control process shown in FIG. 4, FIG. 5 and FIG. 6.

Referring to FIG. 4, it is first checked at step 100 whether a trigger is issued by the user's performance of the lock operation by way of the door lock/unlock operation switches 33a to 33d. When an affirmative determination (YES) is made at step 100, the process of step 110 is executed.

At step 110, it is checked whether the master portable unit 1 exists in the communicable areas of the antennas 31a to 31e. Here, when the master portable unit 1 does not exist in the communicable areas of the antennas 31a to 31e, a condition for performing locking is not satisfied and hence the process is thus ended without change. When it exists, step 120 is executed.

At step 120, it is checked whether the master portable unit 1 exists outside the vehicle compartment. This check is performed by determining in which one of the communicable areas of the antennas 31a to 31e the master portable unit 1 exists. When the control unit 35 transmits the frame indicating the identification code transmission request through the transmitter/receiver device 32 and the antennas 31a to 31e, the determination is performed based on which of the antennas 31a to 31e receives the frame storing the identification code and sent back by the master portable unit 1. Here, when the determination of the inside (not outside) of the vehicle compartment is made, step 130 is executed.

At step 130, it is checked whether the sub-portable unit 2 exists outside the vehicle compartment. This determination is also performed by determining that the sub-portable unit 2 exists in the communicable area of which of the antennas 31a to 31e. When the control unit 35 transmits the frame indicating the identification code transmission request through the transmitter/receiver device 32 and the antennas 31a to 31e, the determination can be performed based on which of the antennas 31a to 31e receives the frame storing the identification code and sent back by the sub-portable unit 2.

Here, when the sub-portable unit 2 does not exist outside the vehicle compartment (NO) but exists inside the vehicle compartment or nowhere in the communicable areas of the antennas 31a to 31e, it is presumed that the user is still in the vehicle compartment or does not use the sub-portable unit 2 and left it in the home. Thus, when the lock operation is performed in this case, it is conceivable that another person has performed the lock operation outside the vehicle compartment. Accordingly, when door locking is performed in this case, the operation is against the intention of the user. Accordingly, in this case, the process is ended without locking.

On the other hand, when the sub-portable unit 2 exists outside the vehicle compartment (YES), it is presumed that the user went out of the vehicle V while holding the sub-portable unit 2 but leaving the master portable unit 1 in the vehicle compartment, and performed the lock operation. In such a case, since the user wants to go out of the vehicle V without taking out the master portable unit 1 from a bag or a jacket, step 140 is executed. At step 140, master portable unit disable control to disable the communication and various operations of the master portable unit 1 is performed. Then, the lock control is performed at step 150.

In the master portable unit disable control (step 140), the master portable unit 1 is not allowed to function as an electronic key even if the master portable unit 1 exists inside the vehicle compartment. For example, communication between the transmitter/receiver device 32 and the master portable unit 17 and the signal corresponding to the operation of the lock switch 11 or the unlock switch 12 of the master portable unit 1 are disabled. Thus, even if an unauthorized person breaks a window and enters the vehicle compartment when the user carries the sub-portable unit 2 and is away from the vehicle V, the operation, such as starting the engine, by using the master portable unit 1 can be made not to be performed.

As the lock control at step 150, the control unit 35 outputs the signal of execution instruction of the lock control to the lock/unlock driver unit 36. By this, for example, an actuator (not shown) is driven and the door is locked. Accordingly, even if the master portable unit 1 is left in the vehicle compartment, the door is locked when the user holds the sub-portable unit 2 and goes out of the vehicle V.

On the other hand, when it is determined at step 120 that the location of the master portable unit 1 is outside the vehicle compartment (YES), step 160 is executed. At step 160, it is checked whether the location of the sub-portable unit 2 is inside the vehicle compartment.

Here, when the sub-portable unit 2 exists inside the vehicle compartment (YES), it is presumed that the user went out of the vehicle V while holding the master portable unit 1 and leaving the sub-portable unit 2 inside the vehicle compartment, and performed the lock operation. In such a case, the sub-portable unit 2 is not used, and the master portable unit 1 is used as usual. Therefore, step 170 is executed to disable the communication and various operations by the sub-portable unit 2. Then, the lock control is performed at step 180.

The sub-portable unit disable control at step 170 is equal to the master portable unit disable control at step 140 except that the object of disabling is the sub-portable unit 2. The disable control is made in the similar way so that the sub-portable unit 2 is made not to function as an electronic key. Besides, the lock control at step 180 is similar to the lock control at step 150. By such control, even if the user goes out of the vehicle V while the sub-portable unit 2 is left in the vehicle V, the door can be locked.

Besides, when it is determined at step 160 that the sub-portable unit 2 exists outside the vehicle compartment or nowhere in the communicable areas of the antennas 31a to 31e (NO), it is presumed that the user went out of the vehicle while holding the sub-portable unit 2 or the sub-portable unit 2 is left in the home and not used at all or the like. Thus, the lock control is performed at step 190 in the similar way as in step 150 or 180. In this way, the control in the case where the lock operation is performed when the engine is not operating is completed.

Referring to FIG. 5, it is first checked at step 200 whether a trigger is issued by the user's performance of the unlock operation on the lock/unlock operation switches 33a to 33d. When an affirmative determination (YES) is made at step 200, subsequent step 210 is executed.

At step 210, it is checked whether the master portable unit 1 exists in the communicable areas of the antennas 31a to 31e. When the master portable unit 1 does not exist in the communicable areas of the antennas 31a to 31e and a condition for performing unlocking is not satisfied (NO), the process is ended without change. When it exists (YES) in the communicable areas, step 220 is executed.

At step 220, it is checked whether the master portable unit 1 exists outside the vehicle compartment. This check is performed by determining in which one of the communicable areas of the antennas 31a to 31e the master portable unit 1 exists. This process may be performed in the similar way as in step 110 of FIG. 4. When it is determined that the master portable unit exists inside and not outside the vehicle compartment (NO), step 230 is executed.

At step 230, it is checked whether the sub-portable unit 2 exists outside the vehicle compartment. This check may also be performed in the similar manner as in step 130 of FIG. 4. Here, when the sub-portable unit 2 exists inside the vehicle compartment or nowhere in the communicable areas of the antennas 31a to 31e (NO), it is presumed that the user still stays inside the vehicle compartment or does not use the sub-portable unit 2 by leaving it in the home. When the unlock operation is performed in this case, it is conceivable that the operation is performed by an unauthorized person outside the vehicle compartment. Accordingly, when the unlocking is performed in this case, such an operation is against the intention of the user, and therefore the unlocking is not performed and the process is ended without change.

On the other hand, when the sub-portable unit 2 exists outside the vehicle compartment (YES), it is presumed that the user went out of the vehicle V while holding the sub-portable unit 2 but leaving the master portable unit 1 in the vehicle compartment, and then returned to the vehicle V and performed the unlock operation. In such a case, since it is conceivable that the user went out of the vehicle V while not taking out the master portable unit 1 from the bag or the jacket, step 240 is executed to perform the unlock control. Then at step 250, master portable unit enable control is performed to allow the master portable unit 1 to function as the electronic key. Thus, the communication and various operations by the master portable unit 1 are enabled again.

Specifically, as the unlock control, the control unit 35 outputs the signal of execution instruction of the unlock control to the lock/unlock driver unit 36. For example, an actuator (not shown) is driven to unlock the door. Accordingly, even if the user goes out while leaving the master portable unit 1 in the vehicle compartment, when the user has the sub-portable unit 2, he/she can return into the vehicle compartment again.

In the master portable unit enable control at step 250, the master portable unit 1 is enabled to function as the electronic key again, although it was impossible to function as the electronic key since the master portable unit disable control was once executed. For example, even if the communication and various operations by the master portable unit 1 are disabled, since the communication and various operations by the master portable unit 1 are again enabled, the user can perform the various operations which can be performed when the master portable unit 1 exists inside the vehicle compartment, such as, for example, the operation of starting the engine by operating the push switch. Accordingly, even if the user goes out while leaving the master portable unit 1 in the vehicle compartment, the master portable unit disable control is once executed, and the communication and various operations by the master portable unit 1 are disabled, the communication and various operations by the master portable unit 1 can be again enabled by performing the unlock operation using the sub-portable unit 2.

On the other hand, when it is determined at step 220 that the location of the master portable unit 1 is outside the vehicle compartment (YES), step 260 is executed. Also at step 260, it is checked whether the location of the sub-portable unit 2 is inside the vehicle compartment in the similar way as in step 160.

Here, when the sub-portable unit 2 exists inside the vehicle compartment (YES), it is presumed that the user went out of the vehicle V while holding the master portable unit 1 and leaving the sub-portable unit 2, and performed the lock operation. In such a case, it is conceivable that the sub-portable unit 2 is not used, but the master portable unit 1 is used as usual. Therefore, step 270 is executed to perform the unlock control. At subsequent step 280, sub-portable unit enable control is performed to allow the sub-portable unit 2 to again function as the electronic key. The unlock control at step 270 is similar to the unlock control at step 250. The sub-portable unit enable control at step 280 is for again enabling the communication by the sub-portable unit 2 when the communication and various operations by the sub-portable unit 2 have been disabled by the execution of the sub-portable unit disable control. Thus, even when the user goes out of the vehicle V while leaving the sub-portable unit 2 in the vehicle V and the communication by the sub-portable unit 2 is disabled by the sub-portable unit disable control, the communication of the sub-portable unit 2 is again enabled if the user has the master portable unit 1 and performs the unlock operation.

Besides, when it is determined at step 260 that the sub-portable unit 2 exists outside the vehicle or nowhere in the communicable areas of the antennas 31a to 31e, it is presumed that the user holds also the sub-portable unit 2 and goes out of the vehicle V or the sub-portable unit 2 is not used but is left in the home or the like. Thus, step 290 is executed to perform the unlock control in the similar manner as in steps 240 or 270. Thus, the unlock operation that is performed when the engine is not operating is completed.

In the take-out warning control process shown in FIG. 6, it is first checked at step 300 whether a trigger is issued by the user's performance of the open/close operation of the door. When an affirmative determination (YES) is made at step 300, step 310 is executed. The open/close operation of the door is determined based on the detection result of the door open/close detection units 34a to 34d.

At step 310, it is checked whether the engine is in operation. This determination is performed by a well-known method, for example, information relating to the engine speed may be acquired from the engine ECU. Only when the engine is operating (YES), step 320 is executed.

At 320, it is checked whether the master portable unit 1 exists outside the vehicle compartment. This determination may be performed in the similar manner as the step 120 of FIG. 4. Here, when it is determined that the master portable unit exists inside the vehicle (NO), step 330 is executed.

At step 330, it is checked whether the location of the sub-portable unit 2 is outside the vehicle compartment. This determination may also be performed in the similar manner as in step 130 of FIG. 4. Here, when the sub-portable unit 2 exists inside the vehicle compartment or nowhere in the communicable areas of the antennas 31a to 31e (NO), the user is still inside the vehicle compartment or does not use the sub-portable unit 2 leaving it in the home. Even if the unlock operation is performed in this state, it is unnecessary to perform the take-out warning or the like. Accordingly, in this case, the process is ended without change.

On the other hand, when the sub-portable unit 2 exists outside the vehicle compartment (YES), it is presumed that the user holds the sub-portable unit 2 and went out of the vehicle V while leaving the master portable unit 1 in the vehicle compartment, and performed the operation of closing the door. In such a case, since the user wants to go out of the vehicle V without taking out the master portable unit 1 from the bag or the jacket, step 340 is executed. At step 340, lock/unlock control by the sub-portable unit 2 is enabled. At step 350, a warning control is stopped.

When the lock/unlock control is enabled at step 340, the sub-portable unit 2 is permitted to be used as the electronic key similarly to the master portable unit 1. Thus, if the user holds the sub-portable unit 2 and goes out of the vehicle compartment, the user can perform locking/unlocking of the door. If the warning control is stopped at step 350, the warning device 37 is not allowed to perform the take-out warning. When the user goes out of the vehicle compartment while the engine is operating and the master portable unit 1 is left in the vehicle compartment, the take-out warning will be performed in the conventional system. However, as long as the user carries the sub-portable unit 1, it is unnecessary to perform the take-out warning since the user recognizes that the master portable unit 1 is placed in the vehicle compartment. Accordingly, in this case, the warning control is stopped so as not to perform the take-out warning. Thus, when the user wants to go out of the vehicle V without taking out the master portable unit 1 from the bag or the jacket, the user may hold the sub-portable unit 2 and go out of the vehicle compartment, so that the lock/unlock operation can be performed by the sub-portable unit 2 without inviting the take-out warning.

On the other hand, when it is determined at step 320 that the location of the master portable unit 2 is outside the vehicle compartment (YES), step 360 is executed to check whether the location of the sub-portable unit 2 is outside the vehicle compartment. This determination may be performed in the similar manner as in step 330.

Here, when the sub-portable unit 2 exists inside the vehicle compartment or nowhere in the communicable areas of the antennas 31a to 31e (NO), it is presumed that the user holds the master portable unit 1 and goes out of the vehicle V in the state where the user does not use the sub-portable unit 2 leaving it in the vehicle compartment or in the home. Accordingly, the state is such that the user takes out the master portable unit 1 while leaving the engine operating. Since it is necessary to perform the take-out warning, step 370 is executed to perform the warning control. As a result, a signal instructing that the take-out warning is to be performed is outputted from the control unit 35 to the warning device 37, and the warning device 37 performs the take-out warning.

When it is determined at step 360 that the sub-portable unit 2 exists outside the vehicle compartment (YES), it is presumed that the user holds also the sub-portable unit 2 and goes out of the vehicle V. Thus, step 380 is executed. After the lock/unlock control by the master portable unit 1 or the sub-portable unit 2 is performed, the warning control is stopped at step 390 so that no take-out warning is issued.

As described above, according to the smart entry system in this embodiment, when the lock/unlock is performed in the state where the engine is not operating, it is checked whether the lock control and the unlock control are performed based on whether the master portable unit 1 and the sub-portable unit 2 exist in the communicable areas of the antennas 31a to 31e. When they exist in the communicable areas, it is checked whether they exist inside the vehicle compartment or outside the vehicle compartment. Further, the master portable unit enable control and disable control, or the sub-portable unit enable control and disable control are performed. Accordingly, the following advantages can be provided.

That is, when the master portable unit 1 is inside the vehicle compartment and the sub-portable unit 2 exists outside the vehicle compartment, the master portable unit disable control is performed and the lock control is performed. Thus, irrespective of the electric field intensity, the lock of the door can be performed without taking out the portable unit put in the bag or the jacket. Accordingly, when the user holds the sub-portable unit 2 and goes out of the vehicle compartment while leaving the master portable unit 1 in the vehicle compartment, locking can be made to be performed. Further, even if an authorized person breaks the window glass and enters the vehicle compartment while the user carries the sub-portable unit 2 and exists outside the vehicle V, the operation such as starting the engine using the master portable unit 1 can be disable. When the master portable unit 1 is inside the vehicle compartment and the user carrying the sub-portable unit 2 returns, the unlock control is performed and the master portable unit enable control is performed. Thus, when the user holds the sub-portable unit 2, goes out of the vehicle compartment while leaving the master portable unit 1 in the vehicle compartment, and returns again, unlocking can be performed. Further, the operation by the master portable unit 1 and the like are enabled, so that the operation such as starting the engine can be performed.

When the master portable unit 1 is inside the vehicle compartment and the sub-portable unit 2 is inside the vehicle compartment or does not exist in the communicable areas of the antennas 31a to 31e, the lock control or unlock control is not performed, Thus, As long as the user is inside the vehicle compartment, the lock control and the unlock control cannot be performed even when the Tock/unlock operation is performed outside the vehicle compartment against the intention of the user.

When the user holds the master portable unit 1 and goes out of the vehicle compartment while leaving the sub-portable unit 2 in the vehicle compartment, the lock control is performed since the user uses the master portable unit 1 as usual. However, the sub-portable unit disable control is performed. Thus, an unauthorized person cannot start the engine by using the sub-portable unit 2.

Further, when the user goes out of the vehicle compartment while the engine is operating, it is determined whether the take-out warning is to be performed based on whether the master portable unit 1 and the sub-portable unit 2 exist in the communicable areas of the antennas 31a to 31e, and whether they exist outside the vehicle compartment or inside the vehicle compartment when they exist in the communicable areas. Accordingly, the following advantages can be obtained.

That is, when the master portable unit 1 exists inside the vehicle compartment and the sub-portable unit 2 is outside the vehicle compartment, the lock/unlock control permission of the sub-portable unit 2 is performed, and the warning control stop is performed. Thus, when the user holds the sub-portable unit 2 and goes out of the vehicle compartment while leaving the master portable unit 1 in the vehicle compartment, locking can be performed by the sub-portable unit 2. In this instance, even when the user goes out of the vehicle compartment without holding the master portable unit 1, the take-out warning is not performed.

As stated above, according to the smart entry system of this embodiment, even if the user does not take out the master portable unit 1 put in the bag or the jacket, locking of the door can be performed. Even if the master portable unit 1 is taken out from the vehicle compartment while the engine is left operating, the take-out warning in not sounded.

The above embodiment may be modified in many ways. For example, the sub-portable unit 2 need not necessarily be provided in the vehicle V. For example, the user may always carry the sub-portable unit 2. In this case, for example, as shown in FIG. 7, the sub-portable unit 2 may be integrated or combined with a wrist watch, so that it may be always carried by the user always.

What is claimed is:

1. A smart entry system comprising:
a portable unit including a master portable unit and a sub-portable unit operable as electronic keys; and
a vehicle-mounted device having a communicable area inside a vehicle compartment and a communicable area outside the vehicle compartment for communication with the portable unit, the vehicle-mounted device being configured to check whether the portable unit exists in the communicable area inside the vehicle compartment or the communicable area outside the vehicle compartment, and whether the portable unit does not exist in either the communicable area inside the vehicle compartment or the communicable area outside the vehicle compartment, and the vehicle-mounted device performing lock control and unlock control of a door based on a result of check operation,
wherein the vehicle-mounted device includes a transmitter/receiver device that communicates with the master portable unit and the sub-portable unit, door lock/unlock operation switches that perform lock and unlock operations of the door at an outside of the vehicle compartment, a control unit that issues an execution instruction of lock control and unlock control of the door based on an operation state of the door lock/unlock operation switches, and a lock/unlock driver unit that executes the lock control and the unlock control based on the execution instruction of the lock control and the unlock control of the door by the control unit, and
wherein the control unit is configured to execute, when the lock operation is performed by the door lock/unlock operation switches, master portable unit disable control to thereby disable the master portable unit to function as the electronic key, and cause the lock/unlock driver unit to perform the lock control, upon determining that the master portable unit is inside the vehicle compartment and the sub-portable unit is outside the vehicle compartment.

2. The smart entry system according to claim 1, wherein:
the control unit is configured to execute, when the lock operation is performed by the door lock/unlock operation switches, sub-portable unit disable control to thereby disable the sub-portable unit to function as the electronic key, and cause the lock/unlock driver unit to perform the lock control, upon determining that the master portable unit is outside the vehicle compartment and the sub-portable unit is inside the vehicle compartment.

3. The smart entry system according to claim 1, wherein:
the control unit is configured to cause, when the lock operation is performed by the door lock/unlock operation switches, the lock/unlock driver unit not to execute the lock control, upon determining that the master portable unit is inside the vehicle compartment and the sub-portable unit is inside the vehicle compartment or nowhere in the communicable areas inside the vehicle compartment and outside the vehicle compartment.

4. The smart entry system according to claim 1, wherein:
the control unit is configured to cause, when the lock operation is performed by the door lock/unlock operation switches, the lock/unlock driver unit to perform the lock control, upon determining that the master portable unit is outside the vehicle compartment and the sub-portable unit is outside the vehicle compartment or nowhere in the communicable areas inside the vehicle compartment and outside the vehicle compartment.

5. The smart entry system according to claim 1, wherein:
the control unit is configured to cause, when the unlock operation is performed by the door lock/unlock operation switches, the lock/unlock driver unit to perform the unlock control, and execute master portable unit enable control to enable the master portable unit to function as the electronic key, upon determining that the master portable unit is inside the vehicle compartment and that the sub-portable unit is outside the vehicle compartment.

6. The smart entry system according to claim 5, wherein:
the control unit is configured to cause, when the unlock operation is performed by the door lock/unlock operation switches, the lock/unlock driver unit to perform the unlock control, and execute sub-portable unit enable control to enable the sub-portable unit to function as the electronic key, and, upon determining that the master portable unit is outside the vehicle compartment and the sub-portable unit is inside the vehicle compartment.

7. The smart entry system according to claim 5, wherein:
the control unit is configured to cause, when the unlock operation is performed by the door lock/unlock operation switches, the lock/unlock driver unit not to perform the unlock control, upon determining that the master portable unit is inside the vehicle compartment and the sub-portable unit is inside the vehicle compartment or nowhere in the communicable areas inside the vehicle compartment and outside the vehicle compartment.

8. The smart entry system according to claim 5, wherein:
the control unit is configured to cause, when the unlock operation is performed by the door lock/unlock operation switches, the lock/unlock driver unit to perform the unlock control, upon determining that the master portable unit is outside the vehicle compartment and the sub-portable unit is outside the vehicle compartment or nowhere in the communicable areas inside the vehicle compartment and outside the vehicle compartment.

9. The smart entry system according to claim 1, wherein:
the vehicle-mounted device includes a door open/close detection unit that detects an open/close operation of the door and a warning device that issues a take-out warning indicating that the portable unit is taken out under condition that the engine is in operation, and
the control unit is configured to stop, when the door open/close detection unit detects that the open/close operation of the door is performed when the engine is operating, take-out warning control that causes the warning device to issue the warning, upon determining that the master portable unit is inside the vehicle compartment and the sub-portable unit is outside the vehicle compartment.

10. A smart entry system comprising:
a portable unit including a master portable unit and a sub-portable unit operable as electronic keys; and
a vehicle-mounted device having a communicable area inside a vehicle compartment and a communicable area outside the vehicle compartment for communication with the portable unit, the vehicle-mounted device being configured to check whether the portable unit exists in the communicable area inside the vehicle compartment or the communicable area outside the vehicle compartment, and whether the portable unit does not exist in either the communicable area inside the vehicle compartment or the communicable area outside the vehicle compartment, and the vehicle-mounted device performing take-out warning control to inform that the portable unit is taken out from the vehicle while an engine is in operation,
wherein the vehicle-mounted device includes a transmitter/receiver device that communicates with the master portable unit and the sub-portable unit, a door open/close detection unit that detects an open/close operation of a door of the vehicle, a control unit that executes the take-out warning control based on a detection result of the door open/close detection unit and whether the engine is in operation, and a warning device that issues a take-out warning based on the take-out warning control, and
wherein the control unit is configured to stop the take-out warning by the take-out warning control, upon determining that the master portable unit exists inside the vehicle compartment and the sub-portable unit is outside the vehicle compartment.

11. The smart entry system according to claim 10, wherein:
the control unit is configured to enable, when the door open/close detection unit detects that the open/close operation of the door is performed when the engine is in operation, lock/unlock control by causing the sub-portable unit to function as the electronic key, upon determining that the master portable unit is inside the vehicle compartment and the sub-portable unit is outside the vehicle compartment.

12. The smart entry system according to claim 10, wherein:
the control unit is configured to enable, when the door open/close detection unit detects that the open/close operation of the door is performed when the engine is in operation, the take-out warning control to cause the warning device issues the take-out warning, upon determining that the master portable unit is outside the vehicle compartment and the sub-portable unit is inside the vehicle compartment or nowhere in the communicable areas inside the vehicle compartment and outside the vehicle compartment.

13. The smart entry system according to claim 10, wherein:
the control unit is configured to enable, when the door open/close detection unit detects that the open/close operation of the door is performed when the engine is in operation, lock/unlock control by both the master portable unit and the sub-portable unit as the electronic keys and stop the take-out warning by the take-out warning control, upon determining that the master portable unit is outside the vehicle compartment and the sub-portable unit is outside the vehicle compartment.
